(19) United States
(12) Patent Application Publication
(10) Pub. No.: US 2011/0002719 A1
(43) Pub. Date: Jan. 6, 2011

(54) IMAGE FORMING APPARATUS, AND TONER AND DEVELOPER USED THEREIN

(76) Inventors: Hyo Shu, Mishima-shi (JP); Masami Tomita, Numazu-shi (JP); Ken Umehara, Chiba-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/880,254

(22) Filed: Sep. 13, 2010

Related U.S. Application Data
(62) Division of application No. 11/672,319, filed on Feb. 7, 2007.

(30) Foreign Application Priority Data
Feb. 7, 2006 (JP) 2006-029355

(51) Int. Cl. G03G 21/00

(52) U.S. Cl. 399/343

(57) ABSTRACT

An image forming method producing images at a speed of from 500 to 1,700 mm/sec, including charging an image bearer; irradiating the charged image bearer to form an electrostatic latent image thereon; developing the electrostatic latent image with a developer comprising a toner, to form a toner image on the image bearer; transferring the toner image onto a recording medium; cleaning the toner remaining on the image bearer after the transferring step; and fixing the toner image on the recording medium, wherein the binder resin includes a crystalline polyester resin and an amorphous resin, wherein a peak ratio (W/R) of a specific peak height (W) of the crystalline polyester resin to a specific peak height (R) of the amorphous resin is from 0.050 to 0.555, and a toner transfer rate T (%) determined by the following formula (1) is from 75 to 100%:

T(%)=(V−A)×100/V (1)

wherein V represents a toner volume (mg/cm²) of the toner image on the image bearer; and A represents a toner volume (mg/cm²) thereof remaining on the image bearer after transfer.

### CROSS-REFERENCE TO RELATED APPLICATION

The present application is a Divisional of U.S. application Ser. No. 11/672,319, filed Feb. 7, 2007, pending, the entire contents of which are hereby incorporated by reference.

### BACKGROUND OF THE INVENTION

1. Field of the Invention

The present invention relates to an image forming apparatus, and more particularly to a high-speed image forming apparatus, and to a toner and a developer used therein.

2. Discussion of the Background

Recently, in the electrophotographic image forming field, faster image formation and higher image quality have typically been required. Particularly, the fixability of a toner, which is one of factors seriously affecting the image quality, deteriorates as the image formation becomes faster. Therefore, it is a critical issue to balance between the fixability of a toner and fast speed image formation.

A toner image is fixed on a paper upon receipt of heat and pressure from a fixer. However, when the image formation becomes faster, the toner image does not receive enough heat and is poorly-fixed on the paper, resulting in peeling of the toner.

One solution that has been considered is to increase the fixing temperature as the image formation becomes faster. However, there is a limit in increasing the temperature in terms of an adverse effect due to increase of temperature and quicker consumption of fixing members in the image forming apparatus, and energy savings. Therefore, a toner is required to improve fixability and have good fixability even at low temperature and high speed.

A variety of trials have been made to improve the fixability of toners.

For example, methods of controlling thermal properties of a resin in a toner are known. However, when the resin has a lower glass transition temperature, the thermostable preservability and fixability strength of the resultant toner deteriorate. When the resin has a lower molecular weight to have a lower F_{1/2} temperature, the resultant toner has a hot offset problem and too high glossiness. In conclusion, even when thermal properties of a resin in a toner are controlled, the resultant toner does not have good low-temperature fixability, thermostable preservability and offset resistance.

Published Unexamined Japanese Patent Applications Nos. 60-90344, 64-15755, 2-82267, 3-229264, 3-41470 and 11-305486 disclose usage of polyester resins having good low-temperature fixability and thermostable preservability instead of conventional styrene-acrylic resins. Published Unexamined Japanese Patent Application No. 62-63940 discloses a trial of adding a specific non-olefin crystalline polymer having a sharp meltability at a glass transition temperature to a binder resin. However, the molecular configuration and weight thereof are not optimized.

Japanese Patent No. 2931899 and Published Unexamined Japanese Patent Application No. 2001-222138 disclose trials of using crystalline polyesters having sharp meltability. A crystalline polyester disclosed in Japanese Patent No. 2931899 has a low acid value and hydroxyl value not greater than 5 and not greater than 20, respectively. Therefore, the crystalline polyester has low affinity with paper and does not have sufficient low-temperature fixability. The molecular configuration and weight of a crystalline polyester disclosed in Published Unexamined Japanese Patent Application No. 2001-222138 are not optimized, either. The toner does not have proper glossiness, has insufficient low-temperature fixability and offset resistance even in a fixing method of applying no or very little release oil to a fixing roller, and undesirable storage stability, transferability, durability, pulverizability and stable chargeability against humidity.

Published Unexamined Japanese Patent Application No. 2002-214833 discloses a method of forming an incompatible sea-island phase-separated structure between a crystalline polyester resin and a non-crystalline polyester resin, and specifying an endothermic maximum peak temperature on a DSC curve of THF-insoluble components in the resin, which is measured with a differential scanning calorimeter to prepare a toner having low-temperature fixability and storage stability. However, the toner does not have sufficient quality.

As mentioned above, a crystalline polyester is effectively used to improve the fixability of the resultant toner particularly used in high-speed image forming apparatuses. However, as an adverse effect, toner filming over a photoreceptor occurs, resulting in production of abnormal solid images having blanks.

Published Unexamined Japanese Patent Application No. 2002-214833 discloses a method of applying a bias having a same polarity as that of a toner to a brush roller to discharging the toner collected thereby and scraping off a filming material attached on a photoreceptor with a cleaning blade when the toner discharged from the brush roller passes through the cleaning blade. However, this is a method of forcibly scraping off the filming material and not a method of preventing filming.

Because of these reasons, a need exists for a high-speed image forming apparatus having low-temperature fixability without toner filming.

### SUMMARY OF THE INVENTION

Accordingly, an object of the present invention is to provide a high-speed image forming apparatus having low-temperature fixability without toner filming.

Another object of the present invention is to provide a toner and a developer used therein.

A further object of the present invention is to provide a toner or a developer container used therein.

Another object of the present invention is to provide a process cartridge used therein.

These objects and other objects of the present invention, either individually or collectively, have been satisfied by the discovery of an image forming apparatus including:

an image bearer;

a charger charging the image bearer;

an irradiator irradiating the image bearer to form an electrostatic latent image on the image bearer;

an image developer developing the electrostatic latent image with a developer including a toner to form a toner image on the image bearer;

a transferer transferring the toner image onto a recording medium;

a cleaner removing the toner remaining on the image bearer after transferred; and

a fixer fixing the toner image on the recording medium,

wherein the image forming apparatus produces images at a speed of from 500 to 1,700 mm/sec and the toner includes at least a binder resin and a colorant,

wherein the binder resin includes at least a crystalline polyester resin and an amorphous resin, wherein a peak ratio (W/R) of a specific peak height (W) of the crystalline polyester resin to a specific peak height (R) of the amorphous resin, which are observed respective spectra when measured by a total reflection method using a Fourier transform infrared spectroanalyzer, is from 0.050 to 0.555, and

wherein a toner transfer rate T (%) determined by the following formula (1) is from 75 to 100%:

T(%)=(V−A)×100/V (1)

wherein V represents a toner volume (mg/cm²) of the toner image on the image bearer; and A represents a toner volume (mg/cm²) thereof remaining on the image bearer after transferred.

### BRIEF DESCRIPTION OF THE DRAWINGS

These and other objects, features and advantages of the present invention will become apparent upon consideration of the following description of the preferred embodiments of the present invention taken in conjunction with the accompanying drawings in which like reference characters designate like corresponding parts throughout and wherein:

FIG. 1 is a schematic cross-sectional view illustrating an embodiment of the image forming apparatus of the present invention;

FIG. 2 is a diagram showing a specific spectrum of the crystal state of a crystalline polyester resin;

FIG. 3 is a diagram showing a specific spectrum of the crystal state of an amorphous polyester resin;

FIG. 4 is a diagram showing a specific spectrum of the crystal state of an amorphous styrene-acrylic resin;

FIG. 5 is a diagram showing a X-ray diffraction spectrum of a crystalline polyester resin; and

FIG. 6 is a diagram showing a X-ray diffraction spectrum of the toner of the present invention.

### DETAILED DESCRIPTION OF THE INVENTION

The present invention provides a high-speed image forming apparatus having low-temperature fixability without toner filming, a toner and a developer, a toner or a developer container and a process cartridge used therein.

In the high-speed image forming apparatus having a linear speed of from 500 to 1,700 mm/s of the present invention, a crystalline polyester resin is effectively used for the toner. Within the context of the present invention, the term “linear speed” refers to a traveling speed of a recording medium.

However, a toner including high levels of crystalline polyester resin at the surface deteriorates in its chargeability. Particularly in a high-speed image forming apparatus, a toner reaches the image bearer in a very short time and in consumed before being fully agitated to be charged.

A low-charged toner adheres to an image bearer more than a high-charged toner. However, a low-charged toner close to the image bearer is difficult to transfer, resulting in poor transfer rate.

A toner remaining on the image bearer after being transferred is gradually anchored thereon by pressure of a cleaning blade or a cleaning brush, an effect known as “toner filming.”

When the toner transfer rate T is from 75 to 100%, toner filming can be prevented.

When the transfer rate is less than 75%, the toner remaining on the image bearer after transfer is gradually anchored thereon by pressure of a cleaning blade or a cleaning brush, resulting in production of abnormal solid images having blanks.

When a crystalline polyester resin is used in a toner, it is essential and effective to control the amount thereof existing at the surface of the toner so as to have a transfer rate not less than 75%. When the amount of the crystalline polyester resin existing at the surface of the toner is not controlled in this manner, the charge quantity thereof varies, resulting in poor transfer rate of the toner. However, when the crystalline polyester resin is simply decreased, the fixability of the resultant toner may deteriorate. Therefore, it is essential not to decrease the total amount thereof and not to separate the crystalline polyester resin out at the surface of the toner.

In the present invention, an amorphous resin is combined with the crystalline polyester resin in order to control the amount thereof present at the surface of the toner. In addition, the following means are preferably combined to improve the transfer rate.

In the present invention, a peak ratio (W/R) of a specific peak height (W) of the crystalline polyester resin to a specific peak height (R) of the amorphous resin, the respective spectra of which are observed when measured by a total reflection method using a Fourier transform infrared spectroanalyzer “Avatar 370 from ThermoElectron GmbH”, is preferably from 0.050 to 0.555, and more preferably from 0.080 to 0.450.

It is quite essential that the peak ratio (W/R) is from 0.050 to 0.555. The peak ratio (W/R) represents a amount of the crystalline polyester resin existing at the surface of a toner.

When less than 0.050, the resultant toner has good filming resistance, but has poor fixability.

When greater than 0.555, the resultant toner has good fixability, but has poor filming resistance.

The peak ratio (W/R) is considered to depend in part on the compatibility of the crystalline polyester resin and the amorphous resin. In the present invention, proportions of toner materials, and conditions of kneading, pulverizing and additive mixing processes are controlled such that the peak ratio (W/R) is from 0.050 to 0.555.

When an amount of the crystalline polyester resin is too large, the crystalline polyester resin existing at the surface of the toner increases. An auxiliary agent recrystallizing the crystalline polyester resin more lowers the compatibility between the crystalline polyester resin and amorphous resin to increase the crystalline polyester resin existing at the surface of the toner.

The peak ratio (W/R) is determined by a total reflection method using a Fourier transform infrared spectroanalyzer. A toner needs to be pressed to have a smooth surface when the peak ratio (W/R) is measured. 1 ton is loaded on 0.6 g of the toner for 30 sec to be a pellet having a diameter of 20 mm.

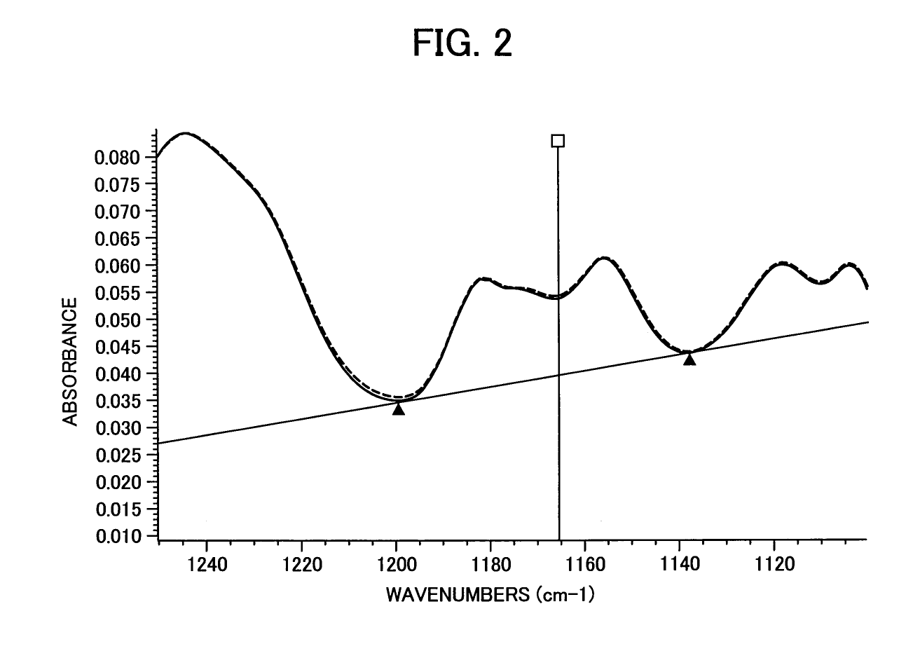

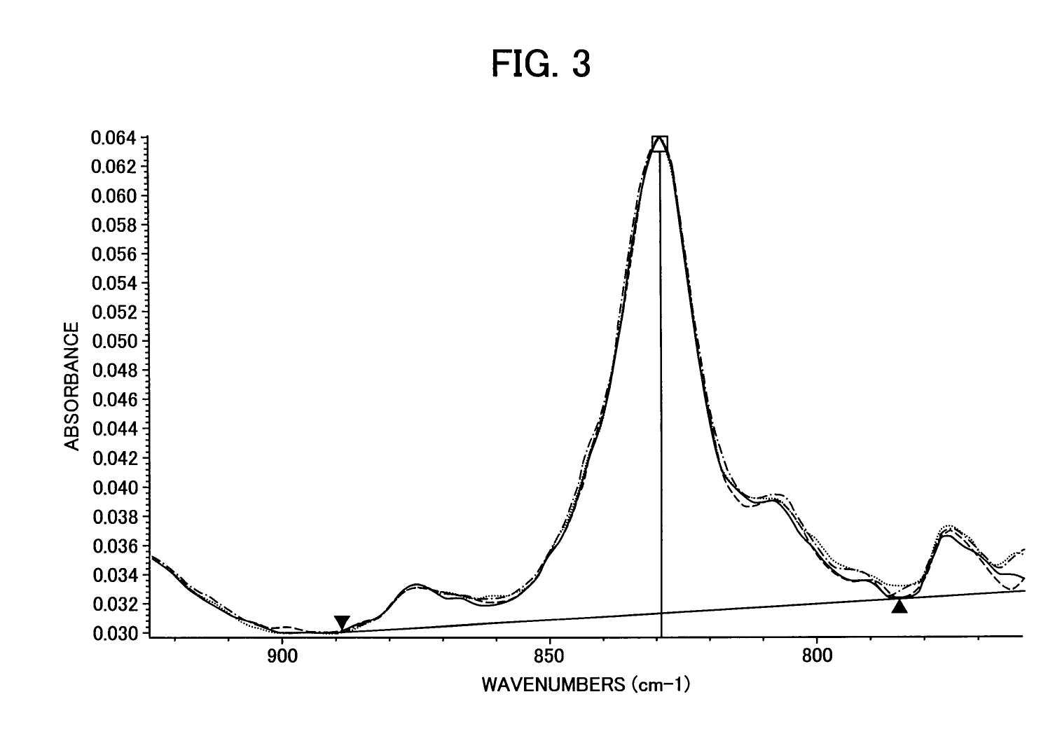

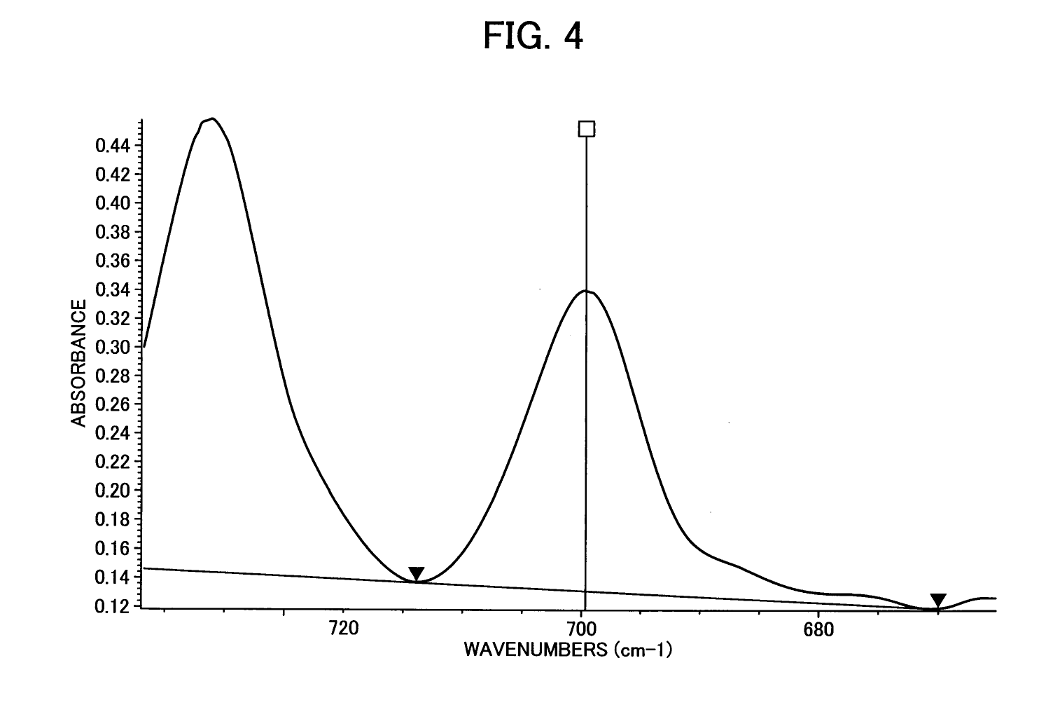

In the present invention, the specific peak height W of the crystalline polyester resin is 1165 cm⁻¹ as FIG. 2 shows, wherein the base line is 1199 to 1137 cm⁻¹. The specific peak height R of the amorphous resin such as a polyester resin is 829 cm⁻¹ as FIG. 3 shows, wherein the base line is 784 to 889 cm⁻¹, and that of an amorphous styrene-acrylic resin is 699 cm⁻¹ as FIG. 4 shows, wherein the base line is 714 to 670 cm⁻¹.

In addition, means of improving the transfer rate include varying transfer conditions such as transfer current, voltage, pressure and materials of the transferer.

The method of measuring the transfer rate T includes:

controlling a toner concentration in a developer and a developing bias of an image developer to form a toner image on a photoreceptor in an amount of from 1.0 to 1.4 mg/cm²;

taping a Scotch tape of 5 cm×2 cm on the toner image;

pressurizing the whole area of the tape with fingers to transfer all the toner image on the photoreceptor onto the tape;

measuring the weight of the toner on the tape V, and subtracting the weight of an original tape from the weight of the tape the toner image is transferred on.

Meanwhile, the weight of the toner remaining on the photoreceptor A after transfer is measured by the same method as above.

T(%)=(V−A)×100/V (1)

A toner having less environmental variation rate of charge quantity has stable chargeability and a stable transfer rate.

A toner preferably has an environmental variation rate not greater than 40%, and more preferably not greater than 30% when measured by the following method. When greater than 40%, the charge quantity of a toner lowers in an image forming apparatus having an inner temperature higher than room temperature. The toner adhering to an image bearer increases and the toner close to the image bearer is difficult to transfer, resulting in poor transfer rate. When the transfer rate is less than 75%, the toner remaining on the image bearer after transfer is gradually anchored thereon by pressure of a cleaning blade or a cleaning brush, resulting in production of abnormal solid images having blanks.

It is effective to control toner materials, quantity thereof used and external additive mixing conditions to stabilize the chargeability of the resultant toner.

For example, when the crystalline polyester resin is decreased, the variation rate of charge quantity of the toner is improved. Meanwhile, when the crystalline polyester resin is increased, the variation rate of charge quantity of the toner deteriorates. In addition, inclusion of hydrophobic silica having a large particle diameter is effectively prevented and titanium is effectively selected to improve charge-up of a toner.

The charge quantity of a toner is measured by the following single mode method.

A toner and a carrier, having a toner concentration of 4% by weight, are left in a specific environment for 2 hrs. The toner and carrier are stirred in a mag roll at 285 rpm for 780 sec to prepare 6 g of a developer. The charge quantity distribution of 1 g of the developer out of 6 g thereof is measured by a single mode method using a V blowoff apparatus from Ricoh Souzou Kaihatsu Kabushiki Kaisha.

A 795-mesh screen is used when blowing.

The single mode method has the following conditions:

Height: 5 mm

Absorptions: 100

Blow: twice

The variation rate of charge quantity of a toner P (%) is determined by the following formula (2):

P(%)=(M−H)×100/(H+M)/2 (2)

wherein M is the charge quantity of a toner at 23° C. and 55% Rh, and H is the charge quantity of a toner at 42° C. and 40% Rh.

Other measuring conditions are based on Japanese Patent No. 3487464, the contents of which are hereby incorporated by reference.

The amorphous resin for use in the present invention is preferably an amorphous polyester resin, and it is essential that a catalyst used when preparing the amorphous polyester resin is a catalyst containing specific titanium (a) having the following formula (1) or (II):

Ti(—X)m(—OH)n (I)

O═Ti(—X)p(—OR)q (II)

wherein X is a residual group of a mono or polyalkanolamine having 2 to 12 carbon atoms wherein a hydrogen atom is excluded from an OH group, and the other OH group may intramolecularly be polycondensed with an OH group directly connected with the same Ti atom to form a ring, or intermolecularly be polycondensed with an OH group directly connected with another Ti atom to form a repeated structure at a polymerization degree of from 2 to 5; R is a hydrogen atom or an alkyl group having 1 to 8 carbon atoms and optionally including 1 to 3 ether bonds; m is an integer of from 1 to 4, n is 0 or an integer of from 1 to 3, and the sum of m and n is 4; p is an integer of from 1 to 2, q is 0 or 1, and the sum of p and q is 2; and when m or p is 2 or more, Xs may be the same or different from each other, respectively.

The catalyst improves the environmental variation rate of charge quantity of a toner. It is considered that this is partly because a charge controlling agent can uniformly be dispersed in the amorphous polyester resin and partly because the amorphous polyester resin and the crystalline polyester resin are more compatible with each other and the crystalline polyester resin separating out on the surface of a toner decreases.

The titanium-containing catalyst having the formula (1) or (II) may be used alone or in combination. X is a residual group of a mono or polyalkanolamine having 2 to 12 carbon atoms wherein a hydrogen atom is excluded from an OH group, and the number of nitrogen atoms, i.e., the sum of primary, secondary and tertiary amino groups is typically 1 to 2, and preferably 1.

The monoalkanolamine includes, but is not limited to, an ethanolamine, a propanolamine, etc. The polyalkanolamine includes, but is not limited to, dialkanolamines such as a diethanolamine, a N-methyldiethanolamine and a N-butyldiethanolamine; trialkanolamines such as a triethanolamine and a tripropanolamine; and tetraalkanolamines such as a N,N,N′,N′-tetrahydroxyethylethylenediamine.

The polyalkanolamine includes one or more OH group, in addition to the residual OH group that H is excluded from to form a Ti—O—C bond, and which may be polycondensed with an OH group directly connected with the same Ti atom to form a ring, or an OH group directly connected with another Ti atom to form a repeated structure. The polymerization degree when forming the repeated structure is from 2 to 5. When not less than 6, the catalyst activity deteriorates and oligomers increase, and therefore the resultant toner has poor blocking resistance.

X is preferably a residual group of the dialkanolamine, particularly a diethanolamine or the trialkanolamine, particularly a triethanolamine, and more preferably a residual group of the triethanolamine.

R is a hydrogen atom or an alkyl group having 1 to 8 carbon atoms and optionally including 1 to 3 ether bonds. Specific examples of the alkyl group having 1 to 8 carbon atoms include, but are not limited to, a methyl group, an ethyl group, a n-propyl group, an isopropyl group, a n-butyl group, a n-hexyl group, a n-octyl group, a β-methoxy ethyl group and β-ethoxy ethyl group, etc. Among these groups, a hydrogen atom and an alkyl group having 1 to 4 carbon atoms and not including an ether bond are preferably used, and a hydrogen atom, an ethyl group and an isopropyl group are more preferably used.

m is an integer of from 1 to 4, and preferably from 1 to 3. n is 0 or an integer of from 1 to 3, and preferably an integer of from 1 to 3. The sum of m and n is 4.

p is an integer of from 1 to 2, q is 0 or 1, and the sum of p and q is 2. When m or p is 2 or more, Xs may be the same or different from each other, and all thereof are preferably the same.

Specific examples of the titanium-containing catalyst (a) having the formula (I) include, but are not limited to, titaniumdihydroxybis(triethanolaminate), titaniumtrihydroxytriethanolaminate, titaniumdihydroxybis(diethanolaminate), titaniumdihydroxybis(monoethanolaminate), titaniumdihydroxybis(monopropanolaminate), titaniumdihydroxybis(N-methyldiethanolaminate), titaniumdihydroxybis(N-butyldiethanolaminate), a reaction product between tetrahydroxytitanium and N,N,N′, N′-tetrahydroxyethylethylenediamine and their intramolecular or intermolecular polycondensates.

Specific examples of the titanium-containing catalyst (a) having the formula (II) include, but are not limited to, titanylbis(triethanolaminate), titanylbis(diethanolaminate), titanylbis(monoethanolaminate), titanylhydroxyethanolaminate, titanylhydroxytriethanolaminate, titanylethoxytriethanolaminate, titanylisopropoxytriethanolaminate and their intramolecular or intermolecular polycondensates.

Among these catalysts, titaniumdihydroxybis(triethanolaminate), titaniumdihydroxybis(diethanolaminate), titanylbis(triethanolaminate), their polycondensates and combinations thereof are preferably used, and titaniumdihydroxybis(triethanolaminate) and its polycondensates, particularly titaniumdihydroxybis(triethanolaminate) itself, are more preferably used.

These titanium-containing catalysts (a) can stably be prepared by reacting marketed titaniumdialkoxybis(alcoholaminate) from DuPont at 70 to 90° C. under the presence of water.

The polycondensed polyester resin forming the toner binder of the present invention includes a polyester resin (AX) which is a polycondensate of polyol and polycarboxylic acid, a modified polyester resin (AY) formed by further reacting polyepoxide (c) with the polyester resin (AX), etc. The AX and AY can be used alone or in combination.

The polyol includes diol (g) and tri- or more valent polyol (h), and the polycarboxylic acid includes dicarboxylic acid (i) and tri- or more valent polycarboxylic acid (j). These can be used alone or in combination.

The polyester resins (AX) and (AY) include, but are not limited to, a linear polyester (AX1) from diol (g) and dicarboxylic acid (i); non-linear polyester (AX2) from diol (g), dicarboxylic acid (i), tri- or more valent polyol (h) and/or tri- or more valent polycarboxylic acid (j); and a modified polyester resin (AY1) formed by reacting polyepoxide (c) with the non-linear polyester (AX2).

The diol (g) preferably has a hydroxyl value of from 180 to 1,900 mg KOH/g. Specific examples of the diol include, but are not limited to, alkylene glycols having 2 to 36 carbon atoms such as ethylene glycol, 1,2-propylene glycol, 1,3-propylene glycol, 1,4-butanediol, and 1,6-hexanediol; alkylene ether glycols having 4 to 36 carbon atoms such as diethylene glycol, triethylene glycol, dipropylene glycol, polyethylene glycol, polypropylene glycol and polybutylene glycol; alicyclic diols having 6 to 36 carbon atoms such as 1,4-cyclohexanedimethanol and hydrogenated bisphenol A; adducts (additional moles of from 1 to 30) of the above-mentioned alicyclic diols with an alkylene oxide having 2 to 4 carbon atoms such as ethylene oxide (EO), propylene oxide (PO) and butylene oxide (BO); and adducts (additional moles of from 2 to 30) of bisphenols such as bisphenol A, bisphenol F and bisphenol S with an alkylene oxide having 2 to 4 carbon atoms such as EO, PO and BO.

In particular, alkylene glycols having 2 to 12 carbon atoms, adducts of bisphenols with an alkylene oxide and a combination thereof are preferably used, and the adducts of bisphenols with an alkylene oxide, alkylene glycols having 2 to 4 carbon atoms and a combination thereof are most preferably used.

In the present invention, the hydroxyl values and acid values are measured by a method specified in JIS K 0070.

The tri- or more valent polyol (h) preferably has a hydroxyl value of from 150 to 1,900 mg KOH/g. Specific examples of the tri- or more valent polyol (h) include, but are not limited to, aliphatic polyols having 3 to 8 or more valences, having 3 to 36 carbon atoms, i.e., alkanepolyols and their intramolecular or intermolecular dehydrated products such as glycerin, trimethylolethane, trimethylolpropane, pentaerythritol, sorbitol, sorbitan, polyglycerin and dipentaerythritol; sugars and their derivatives such as a sucrose and a methylgulcoside; adducts (additional moles of from 1 to 30) of the above-mentioned aliphatic polyol with an alkylene oxide having 2 to 4 carbon atoms such as EO, PO and BO; adducts (additional moles of from 2 to 30) of trisphenols such as trisphenol PA with an alkylene oxide having 2 to 4 carbon atoms such as EO, PO and BO; and adducts (additional moles of from 2 to 30) of novolak resins such as phenolnovolak and cresolnovolak having an average polymerization degree of from 3 to 60 with an alkylene oxide having 2 to 4 carbon atoms such as EO, PO and BO.

In particular, the aliphatic polyol having 3 to 8 or more valences and adducts (additional moles of from 2 to 30) of novolak resins with an alkylene oxide are preferably used, and the adducts of novolak resins with an alkylene oxide are most preferably used.

The dicarboxylic acid (i) preferably has an acid value of from 180 to 1,250 mg KOH/g. Specific examples of the dicarboxylic acid (i) include, but are not limited to, alkanedicarboxylic acids having 4 to 36 carbon atoms, such as succinic acid, adipic acid and sebacic acid and alkenylsuccinic acids such as dodecenylsuccinic acid; alicyclic dicarboxylic acids having 4 to 36 carbon atoms such as a dimer acid (dimeric linoleic acid); alkenedicarboxylic acids such as a maleic acid, a fumaric acid, a citraconic acid and mesaconic acid; and aromatic dicarboxylic acids having 8 to 36 carbon atoms such as phthalic acid, isophthalic acid, terephthalic acid and naphthalene dicarboxylic acid. In particular, alkene dicarboxylic acids having 4 to 20 carbon atoms and aromatic dicarboxylic acids having 8 to 20 carbon atoms are preferably used. In addition, the anhydrides of the above-mentioned acids or their lower alkyl esters having 1 to 4 carbon atoms such as methyl ester, ethyl ester and isopropyl ester can be used.

The tri- or more valent polycarboxylic acid (j) preferably has an acid value of from 150 to 1,250 mg KOH/g. Specific examples of the tri- or more valent polycarboxylic acid include, but are not limited to, aromatic polycarboxylic acids having 9 to 20 carbon atoms such as trimellitic acid and pyromellitic acid; and vinyl polymers of unsaturated carboxylic acids having a number-average molecular weight (Mn) measured by GPC methods of from 450 to 10,000 such as a styrene-maleic acid copolymer, a styrene-acrylic acid copolymer, an α-olefin-maleic acid copolymer and a styrene-fumaric acid copolymer. In particular, the aromatic polycarboxylic acids having 9 to 20 carbon atoms are preferably used, and the trimellitic acid and pyromellitic acid are more preferably used. In addition, the anhydrides of the above-mentioned acids or their lower alkyl esters having 1 to 4 carbon atoms such as methyl ester, ethyl ester and isopropyl ester can be used.

The diol (g), tri- or more valent polyol (h), dicarboxylic acid (i) and tri- or more valent polycarboxylic acid (j) may copolymerize aliphatic or aromatic hydroxycarboxylic acids having 4 to 20 carbon atoms (k) and lactones having 6 to 12 carbon atoms (1).

The aliphatic or aromatic hydroxycarboxylic acids having 4 to 20 carbon atoms (k) include, but are not limited to, a hydroxy stearic acid, a hardened fatty acid of castor oil, etc. The lactones having 6 to 12 carbon atoms (l) include caprolactone, etc.

Specific examples of the polyepoxide (c) include, but are not limited to, polyglycidylethers such as ethyleneglycoldiglycidylether, tetramethyleneglycoldiglycidylether, bisphenol A diglycidylether, bisphenol F diglycidylether, glycerintriglycidylether, pentaerythritoltetraglycidylether and phenolnovolakglycidylether having an average polymerization degree of from 3 to 60; and dieneoxides such as a pentadieneoxide and a hexanedieneoxide. In particular, the polyglycidylethers are preferably used, and the ethyleneglycoldiglycidylether and bisphenol A diglycidylether are more preferably used.

The number of epoxy groups per a molecule of the polyepoxide (c) is preferably from 2 to 8, more preferably from 2 to 6, and furthermore preferably from 2 to 4.

The polyepoxide (c) preferably has an epoxy equivalent of from 50 to 500. The minimum thereof is more preferably 70, and furthermore preferably 80. The maximum thereof is more preferably 300, and most preferably 200. When the number of epoxy groups per molecule and epoxy equivalents are within the above-mentioned ranges, the resultant toner has good developability and fixability.

The polyol and polycarboxylic acid are mixed such that an equivalent ratio ([OH]/[COOH]) between hydroxyl group concentration [OH] and carboxylic group concentration [COOH] is typically from 2/1 to 1/2, preferably from 1.5/1.3 to 1/1.3, and more preferably from 1.3/1 to 1/1.2. Further, a polyol and a polycarboxylic acid are selected such that the resultant polyester toner binder has a glass transition temperature of from 45 to 85° C.

The amorphous polyester resin for use in the present invention can be prepared by a method similar to a method of preparing a typical polyester resin. For example, in an atmosphere of an inert gas such as nitrogen gas, under the presence of a titanium-containing catalyst (a), the reaction temperature is preferably from 150 to 280° C., more preferably from 160 to 250° C., and furthermore preferably from 170 to 240° C. In terms of performing a complete polycondensation reaction, the reaction time is preferably not less than 30 min, and more preferably from 2 to 40 hrs. A vacuum pressure of from 1 to 50 mmHg is effectively performed to improve the reaction speed at the end of the reaction.

The content of the titanium-containing catalyst (a) is preferably from 0.0001 to 0.8%, more preferably from 0.0002 to 0.6%, and furthermore preferably from 0.0015 to 0.55% by weight based on total weight of the resultant polymer in terms of polymerization activity.

Other esterification catalysts can also be used unless the effect of the titanium-containing catalyst (a) is impaired.

Specific examples of the esterification catalysts include, but are not limited to, tin-containing catalysts such as dibutyltinoxide; antimony trioxide; titanium-containing catalysts, besides the titanium-containing catalyst (a), such as titanium alkoxide, titanyloxalatekalium and titaniumterephthalate; zirconium-containing catalysts such as zirconylacetate; germanium-containing catalysts; alkali (earth) metal catalysts, e.g., carboxylate alkali metals or alkali earth metals such as lithium acetate, sodium acetate, kalium acetate, calcium acetate, sodium benzoate and kalium benzoate; and zinc acetate. The content of the other esterification catalysts is preferably from 0 to 0.6% by weight based on total weight of the resultant polymer because the resultant polyester resin is colored less and preferably used in a color toner. The content of the titanium-containing catalyst (a) is preferably from 50 to 100% based on total weight of all the catalysts.

The linear polyester resin (AX1) is prepared by a method of heating the diol (g) and dicarboxylic acid (i) at from 180 to 260° C. under the presence of the titanium-containing catalyst (a) of from 0.0001 to 0.8% by weight based on total weight of the resultant polymer and optionally the other catalysts, and dehydrating and condensing the reaction product at normal pressures and/or reduced pressures.

The non-linear polyester resin (AX2) is prepared by a method of heating the diol (g), dicarboxylic acid (i) and tri- or more valent polyol (h) at from 180 to 260° C. under the presence of the titanium-containing catalyst (a) of from 0.0001 to 0.8% by weight based on total weight of the resultant polymer and optionally the other catalysts, dehydrating and condensing the reaction product at normal pressures and/or reduced pressures, and further reacting the tri- or more valent polycarboxylic acid (j) with the reaction product. The tri- or more valent polycarboxylic acid (j) can be reacted with the diol (g), dicarboxylic acid (i) and tri- or more valent polyol (h) at the same time.

The modified polyester resin (AY1) is prepared by adding the polyepoxide (c) to the non-linear polyester resin (AX2) and subjecting the non-linear polyester resin (AX2) to an elongation reaction at from 180 to 260° C.

The non-linear polyester resin (AX2) preferably has an acid value of from 1 to 60, and more preferably from 5 to 50 when reacted with the polyepoxide (c). When the acid value is from 1 to 60, the polyepoxide (c) does not remain unreacted to have an adverse effect upon the resin and the resin has good thermostability.

The content of the polyepoxide (c) is preferably from 0.01 to 10%, and more preferably from 0.05 to 5% by weight based on total weight of the non-linear polyester resin (AX2).

The toner binder of the present invention can optionally include other resins besides the polycondensed polyester resin.

Specific examples of the other resins include, but are not limited to, styrene resins such as a copolymer of styrene and alkyl (meth)acrylate and a copolymer of styrene and diene monomers; epoxy resins such as a bisphenol A diglycidylether ring-opening polymer; urethane resins such as a polyaddition polymer of diol, diisocyanate and/or tri- or more valent polyol.

The toner binder preferably includes the other resins in an amount of from 0 to 40% by weight, more preferably from 0 to 30% by weight, and furthermore preferably from 0 to 20% by weight.

The crystalline polyester resin (A) for use in the present invention is a crystalline aliphatic polyester resin including an ester bond in its main chain having the following formula (1) in an amount of at least 60% by mol:

—OCO—R—COO—(CH₂)ₙ— (1)

wherein R represents a residual group of a straight-chain unsaturated aliphatic dicarboxylic acid, having a straight-chain unsaturated aliphatic group having 2 to 20, and preferably 2 to 4, carbon atoms; n is an integer of from 2 to 20, and preferably from 2 to 6.

The presence of the crystalline aliphatic polyester resin including an ester bond in its main chain having the formula (1) can be identified by a solid C¹³NMR.

Specific examples of the straight-chain unsaturated aliphatic group include, but are not limited to, straight-chain unsaturated aliphatic groups derived from the straight-chain unsaturated aliphatic dicarboxylic acids, such as maleic acid, fumaric acid, 1,3-n-propenedicarbocylic acid and 1,4-n-butenedicarboxylic acid.

In the formula (1), (CH₂)ₙ represents a straight-chain aliphatic diol residual group.

Specific examples of the straight-chain aliphatic diol residual group include, but are not limited to, straight-chain aliphatic diol derivatives such as ethylene glycol, 1,3-propyleneglycol, 1,4-butanediol and 1,6-hexanediol. The polyester resin (A) including the straight-chain unsaturated aliphatic dicarboxylic acid forms a crystal structure more easily than when including an aromatic dicarboxylic acid.

The polyester (A) can be prepared by a typical method of polycondensing (i) a polycarboxylic acid formed of the straight-chain unsaturated aliphatic dicarboxylic acid or its reactive derivatives such as an acid anhydride, a lower alkyl ester having 1 to 4 carbon atoms and an acid halide and (ii) a polyol formed of the straight-chain aliphatic diol. A small amount of other polycarboxylic acids can optionally be added to (i). The other polycarboxylic acids include (1) an unsaturated aliphatic dicarboxylic acid having a branched chain, (2) saturated aliphatic polycarboxylic acids such as a saturated aliphatic dicarboxylic acid and a saturated aliphatic tricarboxylic acid, (3) aromatic polycarboxylic acids such as an aromatic dicarboxylic acid and an aromatic tricarboxylic acid, etc. The content of the other polycarboxylic acids is typically not greater than 30% by mol, and preferably not greater than 10% by mol based on total mol of the polycarboxylic acids within the limits wherein the resultant polyester resin has crystallinity.

Specific examples of the other polycarboxylic acids include, but are not limited to, dicarboxylic acids such as malonic acid, succinic acid, glutaric acid, adipic acid, suberic acid, sebacic acid, citraconic acid, phthalic acid, isophthalic acid and terephthalic acid; and tri- or more valent polycarboxylic acids such as 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-methylenecarboxypropane, tetra(methylenecarboxyl)methane and 1,2,7,8-octantetracarboxylic acid.

A small amount of other polyols such as aliphatic branched-chain diols, cyclic diols and tri- or more valent polyols can optionally be added to (ii). The content of the other polyols is typically not greater than 30% by mol, and preferably not greater than 10% by mol based on total mol of the polyols within the limits wherein the resultant polyester resin has crystallinity.

Specific examples of the other polyols include, but are not limited to, 1,4-bis(hydroxymethyl)cyclohexane, polyethyleneglycol, adducts of bisphenol A with ethyleneoxide, adducts of bisphenol A with propyleneoxide, glycerin, etc.

The polyester resin (A) preferably has a sharp molecular weight distribution and low molecular weight in terms of low-temperature fixability of the resultant toner. The polyester resin (A) preferably has a weight-average molecular weight (Mw) of from 5,500 to 6,500, a number-average molecular weight (Mn) of from 1,300 to 1,500 and a ratio (Mw/Mn) of from 2 to 5 in a molecular weight distribution by a GPC of its components soluble with o-dichlorobenzene, having an x-axis representing log(M) and a y-axis representing % by weight. The polyester resin (A) preferably has a peak in a scope of from 3.5 to 4.0 (% by weight) and a half width of the peak not greater than 1.5 therein.

The polyester resin (A) typically has a glass transition temperature (Tg) of from 80 to 130° C., and preferably from 80 to 125° C., and a softening point T(F_{1/2}) of from 80 to 130° C., and preferably from 80 to 125° C. so as not to deteriorate thermostable preservability of the resultant toner. When Tg and T(F_{1/2}) are higher than 130° C., the low-temperature fixability of the resultant toner deteriorate because the minimum fixable temperature rises.

The polyester resin (A) has at least one peak at Bragg angles (2θ) of from 20 to 25° in a Cukα X-ray diffraction spectrum, and preferably at from (i) 19 to 20°, (ii) 21 to 22°, (iii) 23 to 25° and (iv) 29 to 31°.

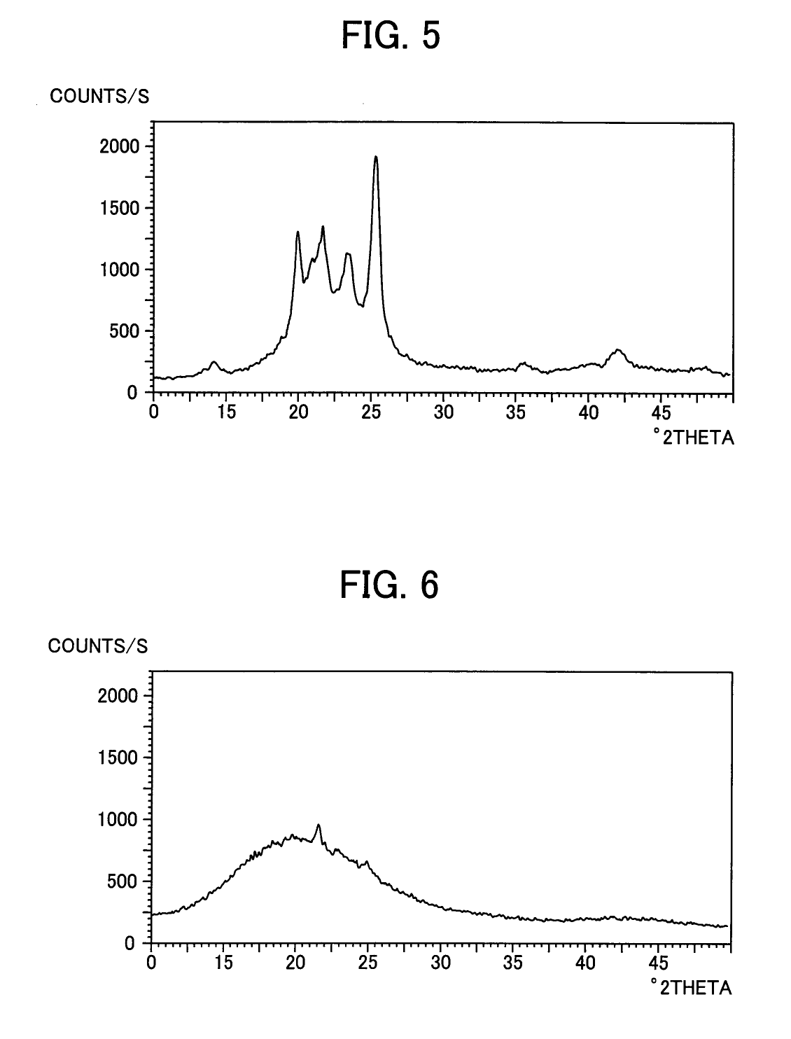

The CuKα X-ray diffraction spectrum is measured by RINT100 from Rigaku Corp., using a Cu tube and a wide-angle goniometer at 50 kV-30 mA. FIG. 5 is a diagram showing a X-ray diffraction spectrum of a crystalline polyester resin, and FIG. 6 is a diagram showing a X-ray diffraction spectrum of the toner of the present invention.

When two or more polyester resins, or at least one polyester resin and other resins are combined, they may be mixed in the shape of powders or melted to be mixed before or when preparing a toner. They are preferably melted at from 80 to 180° C., more preferably from 100 to 170° C., and furthermore preferably from 120 to 160° C. When too low, they are not uniformly mixed. When two or more polyester resins are mixed, they are averaged due to an ester exchange reaction at too high a temperature, and cannot maintain their resin properties.

When they are melted to be mixed, the mixing time is preferably from 10 sec to 30 min, more preferably from 20 sec to 10 min, and furthermore preferably from 30 sec to 5 min. When two or more polyester resins are mixed, they are averaged due to an ester exchange reaction when mixed too long, and cannot maintain their resin properties.

Mixers for melting and mixing the resins include batch mixers such as a reaction tank and continuous mixers. The continuous mixers are preferably used to uniformly mix the resins at a proper temperature in a short time. The continuous mixers include an extruder, a continuous kneader, a three-roll mill, etc. The extruder and continuous kneader are preferably used.

When they are mixed in the shape of powders, they are mixed in a conventional mixer under conventional conditions. The mixing temperature is preferably from 0 to 80° C., and more preferably from 10 to 60° C. The mixing time is preferably not less than 3 min, and more preferably from 5 to 60 min. The mixers include HENSCHEL MIXER, NAUTER MIXER, BUMBURY MIXER, etc. The HENSCHEL MIXER is preferably used.

The crystalline polyester resin (A) preferably has an acid value of not less than 20 mg KOH/g in terms of affinity with papers such that the resultant toner has desired low-temperature fixability, and not greater than 45 mg KOH/g to improve hot offset resistance of the resultant toner.

The crystalline polyester resin (A) preferably has a hydroxyl value of from 5 to 50 mg KOH/g such that the resultant toner has desired low-temperature fixability and good chargeability.

In addition, a wax as a release agent may be used, and the wax preferably has a melting point of from 70 to 150° C. When lower than 70° C., the thermostable preservability of the resultant toner deteriorates. When higher than 150° C., the resultant toner does not have sufficient releasability.

Known waxes can be used. Specific examples of the wax include, but are not limited to, low-molecular-weight polyolefin waxes such as low-molecular-weight polyethylene and low-molecular-weight polypropylene; carbon hydride waxes such as a Fischer-Tropsch wax; natural waxes such as bees wax, carnauba wax, candelilla wax, rice wax, Montan wax; petroleum waxes such as paraffin wax and microcrystalline wax; higher fatty acids such as stearic acid, palmitic acid, myristic acid and their metallic salts; higher fatty acid amide; synthetic ester waxes and their modified waxes.

Among these waxes, the carnauba wax and its modified wax, polyethylene wax and synthetic ester waxes are preferably used. Particularly, the ester pentaerythritoltetrabehenate which is one of the synthetic ester waxes is most preferably used. This is because the carnauba wax and its modified wax, polyethylene wax and synthetic ester wax are finely dispersed in a polyester resin and a polyol resin, and the resultant toner has good offset resistance, transferability and durability.

These waxes can be used alone or in combination, and preferably used in an amount of from 2 to 15% by weight based on total weight of the toner. When the amount is less than 2% by weight, the resultant toner does not have sufficient offset resistance. When greater than 15%, transferability and durability thereof deteriorate.

Known pigments and dyes capable of preparing a yellow, a magenta, a cyan and a black toner can be used as the colorant.

Specific examples of the yellow pigments include, but are not limited to, cadmium yellow, Pigment Yellow 155, benzimidazolone, Mineral Fast Yellow, Nickel Titan Yellow, naples yellow, Naphthol Yellow S, HANSA Yellow G, HANSA Yellow 10G, Benzidine Yellow GR, Quinoline Yellow Lake, Permanent Yellow NCG, Tartrazine Lake, etc.

Specific examples of the orange color pigments include, but are not limited to, Molybdenum Orange, Permanent Orange GTR, Pyrazolone Orange, Vulcan Orange G, Indanthrene Brilliant Orange GK, etc.

Specific examples of the red pigments include, but are not limited to, red iron oxide, quinacridone red, cadmium red, Permanent Red 4R, LITHOL Red, PYRAZOLONE Red, Watching Red calcium salts, Lake Red D, Brilliant Carmine 6B, Eosine Lake, Rhodamine Lake B, Alizarine Lake, Brilliant Carmine 3B, etc.

Specific examples of the violet pigments include, but are not limited to, Fast Violet B, Methyl Violet Lake, etc.

Specific examples of the blue pigments include, but are not limited to, cobalt blue, Alkali Blue, Victoria Blue Lake, Phthalocyanine Blue, metal-free Phthalocyanine Blue, partially chlorinated Phthalocyanine Blue, Fast Sky Blue, INDANTHRENE BLUE BC, etc.

Specific examples of the green pigments include, but are not limited to, chrome green, chrome oxide, Pigment Green B, Malachite Green Lake, etc.

Specific examples of the black pigments include, but are not limited to, azine pigments such as carbon black, oil furnace black, channel black, lamp black, acetylene black and aniline black, metal salts of azo pigments, metal oxides, complex metal oxides, etc.

These pigments are used alone or in combination.

The toner of the present invention can optionally include a charge controlling agent.

Specific examples of the charge controlling agents Include, but are not limited to, Nigrosin; azine dyes including an alkyl group having 2 to 16 carbon atoms disclosed in Japanese Patent Publication No. 42-1627; basic dyes (e.g. C.I. Basic Yellow 2 (C.I. 41000), C.I. Basic Yellow 3, C.I. Basic Red 1 (C.I. 45160), C.I. Basic Red 9 (C.I. 42500), C.I. Basic Violet 1 (C.I. 42535), C.I. Basic Violet 3 (C.I. 42555), C.I. Basic Violet 10 (C.I. 45170), C.I. Basic Violet 14 (C.I. 42510), C.I. Basic Blue 1 (C.I. 42025), C.I. Basic Blue 3 (C.I. 51005), C.I. Basic Blue 5 (C.I. 42140), C.I. Basic Blue 7 (C.I. 42595), C.I. Basic Blue 9 (C.I. 52015), C.I. Basic Blue 24 (C.I. 52030), C.I. Basic Blue 25 (C.I. 52025), Basic Blue 26 (C.I. 44045), C.I. Basic Green 1 (C.I. 42040) and C.I. Basic Green 4 (C.I. 42000)); lake pigments of these basic dyes; C.I. Solvent Black 8 (C.I. 26150); quaternary ammonium salts such as benzoylhexadecylammonium chlorides and decyltrimethyl chlorides; dialkyl tin compounds such as dibutyl or dioctyl tin compounds; dialkyl tin borate compounds; guanidine derivatives; vinyl polymers including amino groups, polyamine resins such as condensation polymers including an amino group, metal complexes of mono azo dyes disclosed in Japanese Patent Publications Nos. 41-20153, 43-27596, 44-6397 and 45-26478; metal complexes of dicarboxylic acid such as Zn, Al, Co, Cr, and Fe complexes of salicylic acid, dialkylsalicylic acid and naphtoic acid; sulfonated copper phthalocyanine pigments, organic boric salts, quaternary ammonium salts including a fluorine atom, calixarene compounds, etc. For a color toner besides a black toner, a charge controlling agent impairing the original color should not be used, and white metallic salts of salicylic acid derivatives are preferably used.

Transferability and durability of the toner of the present invention are further improved by externally adding an inorganic particulate material such as silica, titanium oxide, alumina, silicon carbonate, silicon nitride and boron nitride and a particulate resin onto a mother toner particle of the toner.

This is because these external additives cover a wax deteriorating the transferability and durability and a surface of the toner to decrease contact area thereof. The inorganic particulate material is preferably hydrophobized, and a hydrophobized particulate material of metal oxide such as silica and titanium oxide are preferably used. The particulate resin such as particulate polymethylmethacrylate and polystyrene having an average particle diameter of from 0.05 to 1 μm, which are formed by a soap-free emulsifying polymerization method, are preferably used. Further, a toner including the hydrophobized silica and hydrophobized titanium oxide as external additives, wherein an amount of the hydrophobized silica is larger than that of the hydrophobized titanium oxide, has good charge stability against humidity and an improved transfer rate without filming.

A toner including the above-mentioned particulate inorganic material and external additives having a particle diameter larger than that of conventional external additives such as a silica having a specific surface area of from 20 to 50 m²/g and particulate resin having an average particle diameter of from 1/100 to ⅛ to that of the toner, has good durability. This is because it can be prevented that particulate metal oxide are buried into a mother toner particle by the external additives having a particle diameter larger than that of the particulate metal oxide, although the particulate metal oxide externally added to a toner tend to be buried into the mother toner particle while the toner is mixed and stirred with a carrier, and charged to develop an image in an image developer.

A toner internally including the particulate inorganic material and particulate resin has improved pulverizability as well as transferability and durability although being less than the toner externally including them. When the external and internal additives are used together, it can be prevented that the external additives are buried into the mother toner particle and the resultant toner stably has good transferability and durability.

Specific examples of the hydrophobizing agents include, but are not limited to, dimethyldichlorosilane, trimethylchlorosilane, methyltrichlorosilane, allyldimethylchlorosilane, allylphenyldichlorosilane, benzyldimethylchlorosilane, bromomethyldimethylchlorosilane, α-chloroethyltrichlorosilane, p-chloroethyltrichlorosilane, chloromethyldimethylchlorosilane, chloromethyltrichlorosilane, p-chlorophenyltrichlorosilane, 3-chloropropyltrichlorosilane, 3-chloropropyltrimethoxylsilane, vinyltriethoxysilane, vinylmethoxysilane, vinyl-tris(β-methoxyethoxy)silane, γ-methacryloxypropyltrimethoxysilane, vinyltriacetoxysilane, divinyldichlorosilane, dimethylvinylchlorosilane, octyl-trichlorosilane, decyl-trichlorosilane, nonyl-trichlorosilane, (4-tert-propylphenyl)-trichlorosilane, (4-tert-butylphenyl)-trichlorosilane, dipentyl-dichlorosilane, dihexyl-dichlorosilane, dioctyl-dichlorosilane, dinonyl-dichlorosilane, didecyl-dichlorosilane, didodecyl-dichlorosilane, dihexadecyl-dichlorosilane, (4-tert-butylphenyl)-octyl-dichlorosilane, dioctyl-dichlorosilane, didecenyl-dichlorosilane, dinonenyl-dichlorosilane, di-2-ethylhexyl-dichlorosilane, di-3,3-dimethylpentyl-dichlorosilane, trihexyl-chlorosilane, trioctyl-chlorosilane, tridecyl-chlorosilane, dioctyl-methyl-chlorosilane, octyl-dimethyl-chlorosilane, (4-tert-propylphenyl)-diethyl-chlorosilane, octyltrimethoxysilane, hexamethyldisilazane, hexaethyldisilazane, hexatolyldisilazane, etc. Besides these agents, titanate coupling agents and aluminum coupling agents can be used.

Besides, as an external additive for the purpose of improving cleanability, lubricants such as fine particles of aliphatic metallic salts and polyvinylidene fluoride can be used.

When the toner of the present invention is used in a two-component developer, the toner is mixed with a carrier powder. Any known carriers such as iron powder, ferrite powder, magnetite powder, nickel powder, glass beads and these materials coated with a resin can be used. The carrier preferably has a volume-average particle diameter of from 25 to 200 μm.

A toner container of the present invention is filled with the developer including the toner of the present invention, and any known shapes thereof can be used.

Methods of preparing the toner of the present invention are not particularly limited, and known methods such as a melting and kneading pulverization method; a polymerization method; a polyaddition reaction method using a prepolymer including an isocyanate group; a method of solving with a solvent, removing the solvent and pulverizing; and a melting spray method can be used. Among these methods, the melting and kneading pulverization method, polymerization method, polyaddition reaction method using a prepolymer including an isocyanate group, and method of solving with a solvent, removing the solvent and pulverizing are preferably used.

As an apparatus for melting and kneading a toner, a batch type two-roll kneading machine, a Bumbury's mixer, a continuous biaxial extrusion machine such as KTK biaxial extrusion machines from Kobe Steel, Ltd., TEM biaxial extrusion machines from Toshiba Machine Co., Ltd., TEX biaxial extrusion machines from Japan Steel Works, Ltd., PCM biaxial extrusion machines from Ikegai Corporation and KEX biaxial extrusion machines from Kurimoto, Ltd. and a continuous one-axis kneading machine such as KO-KNEADER from Buss AG are preferably used.

In the polymerization method and polyaddition reaction method using a prepolymer including an isocyanate group, a compulsory emulsification (formation of a liquid drop) by providing a mechanical energy in an aqueous phase is essential. Specific examples of means of providing such mechanical energy include strong stirrers such as a homomixer and ultrasonic vibration energy providers.

A hammer mill, rotoplex, etc. crush, and jet stream and mechanical pulverizers pulverize a toner material to preferably have an average particle diameter of from 3 to 15 μm. Further, the pulverized materials are classified into the materials having particle diameters of from 5 to 20 μm by a wind-force classifier, etc.

An external additive and a mother toner particle are mixed and stirred by a mixer such that the external additive is pulverized to cover a surface of the mother toner particle. It is essential that the external additives such as inorganic fine particles and resin fine particles are uniformly and firmly adhered to the mother toner particle to improve durability of the resultant toner.

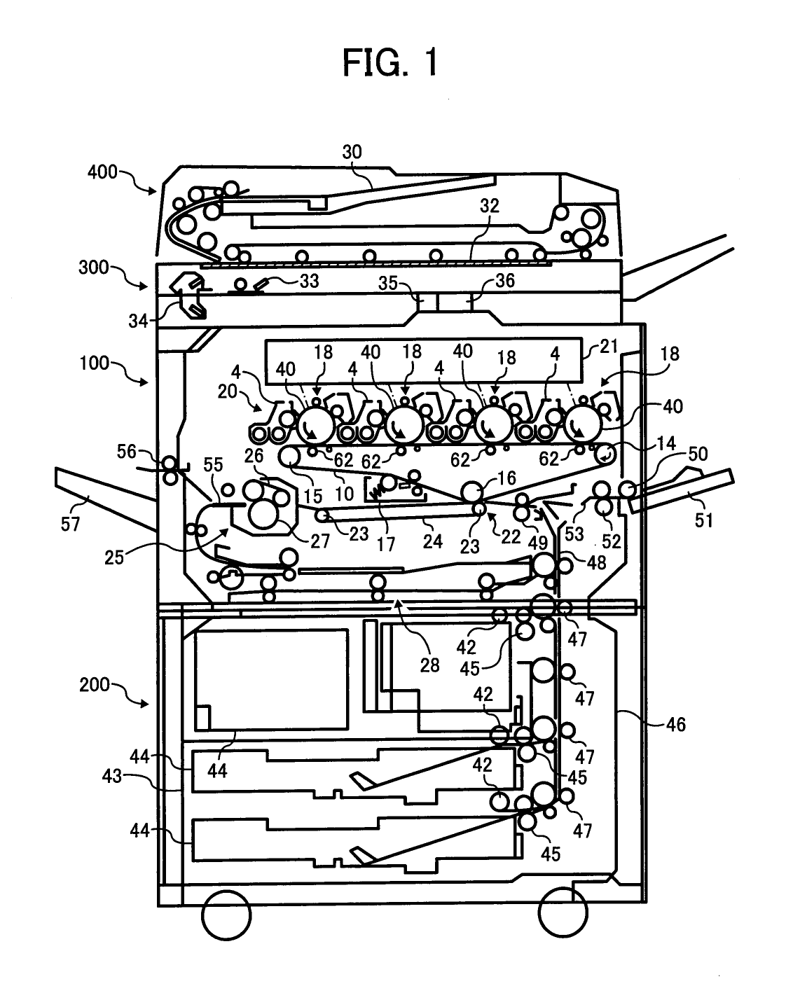

FIG. 1 is a schematic view illustrating an embodiment of a tandem-type electrophotographic image forming apparatus using an indirect transferer. Numeral 100 is a copier, 200 is a paper feeding table, 300 is a scanner on the copier 100 and 400 is an automatic document feeder (ADF) on the scanner 300. The copier 100 includes an intermediate transferer 10 having the shape of an endless belt.

The intermediate transferer 10 is suspended by three suspension rollers 14, 15 and 16 and rotatable in a clockwise direction. On the left of the suspension roller 15, an intermediate transferer cleaner 17 is located to remove a residual toner on an intermediate transferer 10 after an image is transferred.

Above the intermediate transferer 10, 4 image forming units 18 for yellow, cyan, magenta and black colors are located in line from left to right along a transport direction of the intermediate transferer 10 to form a tandem image forming apparatus 20.

Above the tandem image forming apparatus 20, an image developer 21 is located. On the opposite side of the tandem image forming apparatus 20 across the intermediate transferer 10, a second transferer 22 is located. The second transferer 22 includes a an endless second transfer belt 24 and two rollers 23 suspending the endless second transfer belt 24, and is pressed against the suspension roller 16 across the intermediate transferer 10 and transfers an image thereon onto a sheet.

Beside the second transferer 22, a fixer 25 fixing a transferred image on the sheet is located. The fixer 25 includes an endless belt 26 and a pressure roller 27 pressed against the belt.

The second transferer 22 also includes a function of transporting the sheet an image is transferred on to the fixer 25. As the second transferer 22, a transfer roller and a non-contact charger may be used. However, they are difficult have such a function of transporting the sheet.

In FIG. 1, below the second transferer 22 and the fixer 25, a sheet reverser 28 reversing the sheet to form an image on both sides thereof is located in parallel with the tandem image forming apparatus 20.

An original is set on a table 30 of the ADF 400 to make a copy, or on a contact glass 32 of the scanner 300 and pressed with the ADF 400.

When a start switch (not shown) is put on, a first scanner 33 and a second scanner 34 scans the original after the original set on the table 30 of the ADF 400 is fed onto the contact glass 32 of the scanner 300, or immediately when the original set thereon. The first scanner 33 emits light to the original and reflects reflected light therefrom to the second scanner 34. The second scanner further reflects the reflected light to a reading sensor 36 through an imaging lens 35 to read the original.

When a start switch (not shown) is put on, a drive motor (not shown) rotates one of the suspension rollers 14, 15 and 16 such that the other two rollers are driven to rotate, to rotate the intermediate transferer 10. At the same time, each of the image forming units 18 rotates a photoreceptor 40 and forms a single-colored image, i.e., a black image, a yellow image, a magenta image and cyan image on each photoreceptor 40. The single-colored images are sequentially transferred onto the intermediate transferer 10 to form a full-color image thereon.

On the other hand, when start switch (not shown) is put on, one of paper feeding rollers 42 of paper feeding table 200 is selectively rotated to take a sheet out of one of multiple-stage paper cassettes 44 in a paper bank 43. A separation roller 45 separates sheets one by one and feed the sheet into a paper feeding route 46, and a feeding roller 47 feeds the sheet into a paper feeding route 48 of the copier 100 to be stopped against a resist roller 49.

Otherwise, a paper feeding roller 50 is rotated to take a sheet out of a manual feeding tray 51, and a separation roller 52 separates sheets one by one and feed the sheet into a paper feeding route 53 to be stopped against a resist roller 49.

Then, in timing with a synthesized full-color image on the intermediate transferer 10, the resist roller 49 is rotated to feed the sheet between the intermediate transferer 10 and the second transferer 22, and the second transferer transfers the full-color image onto the sheet.

The sheet the full-color image is transferred thereon is fed by the second transferer 22 to the fixer 25. The fixer 25 fixes the image thereon upon application of heat and pressure, and the sheet is discharged by a discharge roller 56 onto a catch tray 57 through a switch-over click 55. Otherwise, the switch-over click 55 feeds the sheet into the sheet reverser 28 reversing the sheet to a transfer position again to form an image on the backside of the sheet, and then the sheet is discharged by the discharge roller 56 onto the catch tray 57.

On the other hand, the intermediate transferer 10 after transferring an image is cleaned by the intermediate transferer cleaner 17 to remove a residual toner thereon after the image is transferred, and ready for another image formation by the tandem image forming apparatus 20.

A process cartridge including an image developer and at least one of an image bearer, a charger and a cleaner may be used for the image forming apparatus of the present invention, which is detachable therefrom.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis Examples of Crystalline Polyester Resin

### Synthesis Example 1

### Synthesis of a Crystalline Polyester Resin No. 1

In a 5 liter four-opening flask equipped with a nitrogen inlet tube, a dewatering tube, a stirrer and a thermocouple, 25 moles of 1,4-butanediol, 23.75 moles of fumaric acid, 1.65 moles of trimellitic acid anhydride and 5.3 g of hydroquinone are reacted for 5 hrs at 160° C. The mixture is further reacted for 1 hr at 200° C. and is reacted at 8.3 KPa for 1 hr to prepare a crystalline polyester resin No. 1.

### Synthesis Example 2

### Synthesis of a Crystalline Polyester Resin No. 2

The procedures of preparation for the crystalline polyester resin No. 1 in Synthesis Example 1 are repeated to prepare crystalline polyester resin No. 2 except for changing the materials to the following materials.

### (No. 2)

| | | |
|---|---|---|
| 1,4-butanediol | 23.75 | moles |
| Ethyleneglycol | 1.25 | moles |
| Fumaric acid | 22.75 | moles |
| Trimellitic acid anhydride | 1.65 | moles |
| Hydroquinone | 4.8 | g |

### Synthesis Example of Amorphous Polyester Resin

### Synthesis of Titanium-Containing Catalyst (a)

In a reaction tank having a cooling tube, a stirrer and a nitrogen inlet tube capable of bubbling in a liquid, an aqueous solution including titaniumdihydroxybis (triethanolaminate) in an mount of 80% by weight is gradually heated to have a temperature of 90° C. while bubbled with nitrogen, and is subjected to hydrolysis for 4 hrs at 90° C. to prepare titaniumdihydroxybis(triethanolaminate).

### [Synthesis of Linear Polyester Resin (AX1-1)]

430 parts of an adduct of bisphenol A with 2 moles of propyleneoxide, 300 parts an adduct of bisphenol A with 3 moles of propyleneoxide, 257 parts of terephthalic acid, 65 parts of isophthalic acid, 10 parts of trimellitic acid anhydride and 2 parts of the titaniumdihydroxybis(triethanolaminate) as a condensation catalyst are reacted in a reaction tank having a cooling tube, a stirrer and a nitrogen inlet tube at 220° C. for 10 hrs under a nitrogen stream while removing water being produced to prepare a reaction product. The reaction product is further reacted while dehydrated under a vacuum pressure of 5 to 20 mm Hg, and is cooled to room temperature and pulverized when having an acid value of 5 to prepare a linear polyester resin (AX1-1).

The linear polyester resin (AX1-1) does not include a THF-insoluble component, and has an acid value of 7, a hydroxyl value of 12, a Tg of 60° C., Mn of 6,940 and Mw of 19,100, and includes a component having a molecular weight not greater than 1,500 in an amount of 1.2% by weight.

### [Synthesis of Non-Linear Polyester Resin (AX2-1)]

350 parts of an adduct of bisphenol A with 2 moles of ethyleneoxide, 326 parts an adduct of bisphenol A with 3 moles of propyleneoxide, 278 parts of terephthalic acid, 40 parts of isophthalic acid and 2 parts of the titaniumdihydroxybis (triethanolaminate) as a condensation catalyst are reacted in a reaction tank having a cooling tube, a stirrer and a nitrogen inlet tube at 230° C. for 10 hrs under a nitrogen stream while removing water being produced to prepare a reaction product. The reaction product is further reacted while dehydrated under a vacuum pressure of 5 to 20 mm Hg, and is cooled to have a temperature of 180° C. when having an acid value not greater than 2. After 62 parts of trimellitic acid anhydride is added thereto, the reaction product is further reacted for 2 hrs under a normal pressure while sealed, and is cooled to room temperature and pulverized to prepare a non-linear polyester resin (AX2-1). The non-linear polyester resin (AX2-1) does not include a THF-insoluble component, and has an acid value of 35, a hydroxyl value of 17, a Tg of 69° C., Mn of 3,920 and Mw of 11,200, and includes a component having a molecular weight not greater than 1,500 in an amount of 0.9% by weight.

### [Synthesis of Amorphous Polyester Resin A]

400 parts of the linear polyester resin (AX1-1) and 600 parts of the non-linear polyester resin (AX2-1) are melted and mixed in a continuous kneader at a jacket temperature of 150° C. for 3 min. The melted resins are cooled with a steel belt cooler to have a temperature of 40° C. in 4 min and pulverized to prepare the amorphous polyester resin A of the present invention.

### [Synthesis of Linear Polyester Resin (CAX1-1)]

The procedure for preparation of the linear polyester resin (AX1-1) is repeated to prepare a linear polyester resin (CAX1-1) except for replacing the titaniumdihydroxybis(triethanolaminate) with titaniumtetraisopropoxide. Since the reaction stopped in mid-course because the catalyst is deactivated, 2 parts of the titaniumtetraisopropoxide are added for 4 times in mid-course to prepare a comparative linear polyester resin (CAX1-1).

The comparative linear polyester resin (CAX1-1) does not include a THF-insoluble component, and has an acid value of 7, a hydroxyl value of 12, a Tg of 58° C., Mn of 6,220 and Mw of 18,900, and includes a component having a molecular weight not greater than 1,500 in an amount of 2.2% by weight.

### [Synthesis of Non-Linear Polyester Resin (CAX2-1)]

The procedure for preparation of the linear polyester resin (AX2-1) is repeated to prepare a non-linear polyester resin (CAX2-1) except for replacing the titaniumdihydroxybis (triethanolaminate) with titaniumtetraisopropoxide. The reaction is performed under a normal pressure for 16 hrs and 8 hrs under a reduced pressure. Since the reaction speed is slow, 2 parts of the titaniumtetraisopropoxide are added for 3 times in mid-course to prepare a comparative non-linear polyester resin (CAX2-1).

The comparative linear polyester resin (CAX2-1) does not include a THF-insoluble component, and has an acid value of 34, a hydroxyl value of 16, a Tg of 68° C., Mn of 3,420 and Mw of 12,100, and includes a component having a molecular weight not greater than 1,500 in an amount of 2.1% by weight.

### [Synthesis of Amorphous Polyester Resin B]

400 parts of the linear polyester resin (CAX1-1) and 600 parts of the non-linear polyester resin (CAX2-1) are melted and mixed in a continuous kneader at a jacket temperature of 150° C. for 3 min. The melted resins are cooled with a steel belt cooler to have a temperature of 40° C. in 4 min and pulverized to prepare the amorphous polyester resin B.

### Example 1

### Toner Production by a Kneading and Pulverizing Method

The following toner constituents are fully mixed with a blender to prepare a mixture.

| | |
|---|---|
| Crystalline polyester resin No. 1 | 35 |
| Amorphous polyester resin B | 65 |
| having a Tg of 59° C. and a Mw of 17,000 | |
| Polyolefin wax | 5 |
| having a melting point of 151° C. | |
| Charge controlling agent | 2 |
| (Metallic salt of salicylic acid derivative) | |
| Colorant | 6 |
| (Copper phthalocyanine blue pigment) | |

The mixture is melted and kneaded in a biaxial extruder at 140° C., an extrusion speed of 10 kg/hr and a roller gap of 2 mm for 48 hrs. The mixture is then cooled, pulverized and classified to prepare a mother toner having a volume-average particle diameter of 7.6 μm. 0.4 parts of a hydrophobic silica having a hexamethyldisilazane treated surface and an average primary particle diameter of 0.02 μm as an external additive are mixed with 100 parts of the mother toner using a HENSCHEL MIXER at 1,500 rpm for 8 times, each of which includes mixing for 60 sec and pausing for 60 sec to prepare a cyan color toner. The transfer current is 30 μA for filming evaluation.

The crystalline polyester resins and toners are evaluated by the following measuring methods and evaluation methods. The results are shown in Tables 1, 2-1 and 2-2.

### <Measuring Method>

(1) Method of Measuring Peak Ratio of Crystalline Polyester Resin

The peak ratio (W/R) is determined by a total reflection method using a Fourier transform infrared spectroanalyzer. A toner needed to be pressed to have a smooth surface when the peak ratio (W/R) is measured. 1 ton is loaded on 0.6 g of the toner for 30 sec to be a pellet having a diameter of 20 mm.

In the present invention, the specific peak height W of the crystalline polyester resin is 1165 cm⁻¹ as FIG. 2 shows, wherein the base line is 1199 to 1137 cm⁻¹. The specific peak height R of the amorphous resin such as a polyester resin is 829 cm⁻¹ as FIG. 3 shows, wherein the base line is 784 to 889 cm⁻¹, and that of an amorphous styrene-acrylic resin is 699 cm⁻¹ as FIG. 4 shows, wherein the base line is 714 to 670 cm⁻¹.

(2) Method of Measuring Transfer Rate

The method of measuring the transfer rate T includes:

controlling a toner concentration in a developer and a developing bias of an image developer to form a toner image on a photoreceptor in an amount of from 1.0 to 1.4 mg/cm²;

taping a Scotch tape of 5×2 cm on the toner image;

pressurizing the whole area of the tape with fingers to transfer all the toner image on the photoreceptor onto the tape;

measuring the weight of the toner on the tape V, and subtracting the weight of an original tape from the weight of the tape the toner image is transferred on.

Meanwhile, the weight of the toner remaining on the photoreceptor A after transfer is measured by the same method as above.

T(%)=(V−A)×100/V (1)

(3) Single Mode Method of Measuring Charge Quantity with V Blowoff Apparatus

The charge quantity of a toner is measured by the following single mode method.

A toner and a carrier, having a toner concentration of 4% by weight, are left in a specific environment for 2 hrs. The toner and carrier are stirred in a mag roll at 285 rpm for 780 sec to prepare 6 g of a developer. The charge quantity distribution of 1 g of the developer out of 6 g thereof is measured by a single mode method using a V blowoff apparatus from Ricoh Souzou Kaihatsu Kabushiki Kaisha.

A 795-mesh screen is used when blowing.

The single mode method has the following conditions:

Height: 5 mm

Absorptions: 100

Blow: twice

The variation rate of charge quantity of a toner P (%) is determined by the following formula (2):

P(%)=(M−H)×100/(H+M)/2 (2)

wherein M is the charge quantity of a toner at 23° C. and 55% Rh, and H is the charge quantity of a toner at 42° C. and 40% Rh.

Other measuring conditions are based on Japanese Patent No. 3487464.

(4) Method of Measuring Acid and Hydroxyl Values of Resin

Measuring methods of an acid value and a hydroxyl value of a resin are based on the methods specified in JIS K0070. However, when a sample is not dissolved, solvents such as dioxane, THF and o-dichlorobenzene are used.

(5) Method of Measuring Melting Point of Wax

TG-DSC system TAS-100 from Rigaku Corp. is used to measure Tg.

First, about 10 mg of a sample in an aluminum container is loaded on a holder unit, which is set in an electric oven. After the sample is heated in the oven at from 25° C. to 180° C. at a programming speed of 10° C. The melting point is determined from a contact point between a tangent of a heat absorption curve close to the melting point and a base line using an analyzer in TAS-100.

(6) Method of Measuring System Speed

100 copies are continuously produced in the longitudinal direction for A sec and the system speed (B) is determined by the following formula:

B(mm/sec)=100×297 mm/A sec

### <Evaluation Method>

(1) Filming Resistance

The following materials are dispersed by a homomixer for 10 min to prepare a silicone-coating liquid solution.

| | |
|---|---|
| Silicone resin solution | 132.2 |
| having a solid content of 23% by weight | |
| SR2410 from Dow Corning Toray Silicone Co., Ltd. | |
| Amino silane | 0.66 |
| having a solid content of 100% by weight | |
| SH6020 from Dow Corning Toray Silicone Co., Ltd. | |
| Electroconductive particulate material 1 | 31 |
| (Surface-treated alumina having a tin dioxide under layer | |
| and an indium oxide upper layer including a tin dioxide, | |
| an average particle diameter of 0.35 μm and a specific | |
| resistivity of 3.5 Ω · cm) | |
| Toluene | 300 |

The silicone-coating liquid solution is coated and dried on a calcined Mn ferrite powder having a weight-average particle diameter of 70 μm by SPIRA COTA, wherein the temperature is 40° C., from OKADA SEIKO CO., LTD. such that the coated film has a thickness of 0.15 μm to prepare a carrier. The resultant carrier is calcined in an electric oven at 300° C. for 1 hr, and after cooled, the carrier is sieved through openings of 125 μm to prepare a [carrier 1].

A two-component developer including 4% by weight of the cyan toner prepared as above and 96% by weight of the carrier 1 is set in a modified copier, imagio NEO C600, from Ricoh Company, Ltd. Before and after 100,000 images are produced thereby (50,000 images/day), three A3 black solid images are produced to visually evaluate hollow images.

The linear speed is 1,650 mm/sec, the developing gap is 1/26 mm, the doctor blade gap is 1.6 mm and the reflection photosensor is off. The image bearer, image developer and transferer are controlled to have temperatures of from 30 to 48° C.

The filming resistance is evaluated as follows.

⊚: Very good because of very few hollow images

◯: Good because of a few hollow images

Δ: Poor because of not a few hollow images

X: Very poor because of many hollow images

(2) Low-Temperature Fixability

The minimum fixable temperature is measured, changing the temperature of the fixing roller by 5° C. of the same modified copier, imagio NEO C600, from Ricoh Company, Ltd. An oil is not applied to the fixing roller and full-color PPC paper TYPE 6200 from Ricoh Company, Ltd. is used as a transfer paper.

Image density before and after the copy images having an image density of 1.2 when measured by a Macbeth densitometer, which are produced at respective temperatures are scraped by a clock meter equipped with a sand eraser for 10 times are measured to determine fixability in the following formula:

fixability (%)=image density after scrape/image density before scrape×100

A temperature to achieve fixability of 70% or more is determined as a minimum fixable temperature. The low-temperature fixability is evaluated as follows:

⊚: toner starts to fix at quite a low temperature, has a low minimum fixable temperature and good low-temperature fixability.

◯: toner has good low-temperature fixability.

Δ: toner has a similar minimum fixable temperature to that of a conventional toner.

X: toner has a higher minimum fixable temperature than that of a conventional toner, and has poor low-temperature fixability.

### Comparative Example 1

The procedure of preparation and evaluation of the toner in Example 1 are repeated except for changing the transfer current to 25 μA.

### Example 2

The procedure of preparation and evaluation of the toner in Example 1 are repeated except for mixing 0.4 parts of the external additive with 100 parts of the mother toner by a HENSCHEL MIXER at 1,000 rpm for 5 times, each of which includes mixing for 60 sec and pausing for 60 sec.

### Example 3

The procedure of preparation and evaluation of the toner in Example 1 are repeated except for changing the crystalline polyester resin No. 1 and amorphous polyester resin B as follows:

| | |
|---|---|
| Crystalline polyester resin No. 2 | 30 |
| Amorphous polyester resin B | 70 |

### Comparative Example 2

The procedure of preparation and evaluation of the toner in Example 1 are repeated except for changing the crystalline polyester resin No. 1 and amorphous polyester resin B as follows:

| | |
|---|---|
| Crystalline polyester resin No. 1 | 4 |
| Amorphous polyester resin B | 96 |

### Example 4

The procedure of preparation and evaluation of the toner in Example 3 are repeated except for changing the amorphous polyester resin B as follows:

| | |
|---|---|
| Amorphous polyester resin A | 70 |

### Example 5

The procedure of preparation and evaluation of the toner in Example 4 are repeated except for changing the wax as follows:

| | |
|---|---|
| Polyolefin wax | 5 |
| having a melting point of 145° C. | |

TABLE 1

| | | | | Hydroxyl |
|---|---|---|---|---|
| | | | Acid Value | Value |
| | T(F_{1/2}) ° C. | Tg (° C.) | (mg KOH/g) | (mg KOH/g) |
| Crystalline | 131 | 131 | 15 | 53 |
| polyester | | | | |
| resin No. 1 | | | | |
| Crystalline | 125 | 125 | 22 | 48 |
| polyester | | | | |
| resin No. 2 | | | | |

TABLE 2-1

| | Crystalline | Amorphous | | Transfer |
|---|---|---|---|---|
| | polyester | polyester | | Rate |
| | resin | resin | W/R | (%) |
| Example 1 | No. 1 | B | 0.553 | 76 |
| Comparative | No. 1 | B | 0.553 | 73 |
| Example 1 | | | | |
| Example 2 | No. 1 | B | 0.553 | 85 |
| Example 3 | No. 2 | B | 0.545 | 92 |
| Comparative | No. 1 | B | 0.048 | 98 |
| Example 2 | | | | |
| Example 4 | No. 2 | A | 0.450 | 95 |
| Example 5 | No. 2 | A | 0.450 | 85 |

TABLE 2-2

| | Toner charge | Melting | | |
|---|---|---|---|---|
| | variation | Point of Wax | Filming | Low-temperature |
| | (%) | (° C.) | Resistance | Fixability |
| Example 1 | 43 | 151 | Δ | ⊚ |
| Comparative | 43 | 151 | X | ⊚ |
| Example 1 | | | | |
| Example 2 | 38 | 151 | ◯ | ⊚ |
| Example 3 | 25 | 151 | ⊚ | ◯ |
| Comparative | 18 | 151 | ⊚ | X |
| Example 2 | | | | |
| Example 4 | 20 | 151 | ⊚ | Δ |
| Example 5 | 21 | 145 | ◯ | Δ |

This application claims priority and contains subject matter related to Japanese Patent Application No. 2006-029355 filed on Feb. 7, 2006, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An image forming method, comprising:
charging an image bearer;
irradiating the charged image bearer to form an electrostatic latent image thereon;
developing the electrostatic latent image with a developer comprising a toner, to form a toner image on the image bearer;
transferring the toner image onto a recording medium;
cleaning the toner remaining on the image bearer after the transferring step; and
fixing the toner image on the recording medium;
wherein the image forming method produces images at a speed of from 500 to 1,700 mm/sec and the toner comprises a binder resin and a colorant,
wherein the binder resin comprises a crystalline polyester resin and an amorphous resin, wherein a peak ratio (W/R) of a specific peak height (W) of the crystalline polyester resin to a specific peak height (R) of the amorphous resin, when respective spectra are observed and measured by a total reflection method using a Fourier transform infrared spectroanalyzer, is from 0.050 to 0.555, and
wherein a toner transfer rate T (%) determined by the following formula (1) is from 75 to 100%:
T(%)=(V−A)×100/V (1)
wherein V represents a toner volume (mg/cm²) of the toner image on the image bearer; and A represents a toner volume (mg/cm²) thereof remaining on the image bearer after transfer.

2. The image forming method of claim 1, wherein the developer is a two-component developer including the toner in an amount of 4% by weight and a magnetic particulate carrier, and wherein the toner has a variation rate P (%) of charge quantity determined by the following formula (2):
P(%)=(M−H)×100/(H+M)/2 (2)
wherein M is the charge quantity of a toner at 23° C. and 55% Rh, and H is the charge quantity of a toner at 42° C. and 40% Rh.

3. The image forming method of claim 1, wherein the amorphous resin is a polyester resin formed in the presence of a titanium-containing catalyst (a) having the following formula (I) or (II):
Ti(—X)m(—OH)n (I)
O═Ti(—X)p(—OR)q (II)
wherein X is a residual group of a mono or polyalkanolamine having 2 to 12 carbon atoms wherein a hydrogen atom is excluded from an OH group, and the other OH group may intramolecularly be polycondensed with an OH group directly connected with the same Ti atom to form a ring, or intermolecularly be polycondensed with an OH group directly connected with another Ti atom to form a repeated structure at a polymerization degree of from 2 to 5; R is a hydrogen atom or an alkyl group having 1 to 8 carbon atoms and optionally including 1 to 3 ether bonds; m is an integer of from 1 to 4, n is 0 or an integer of from 1 to 3, and the sum of m and n is 4; p is an integer of from 1 to 2, q is 0 or 1, and the sum of p and q is 2; and when m or p is 2 or more, Xs may be the same or different from each other, respectively.

4. The image forming method of claim 3, wherein the titanium-containing catalyst (a) is a catalyst of formula (1) selected from the group consisting of titaniumdihydroxybis(triethanolaminate), titaniumtrihydroxytriethanolaminate, titaniumdihydroxybis(diethanolaminate), titaniumdihydroxybis(monoethanolaminate), titaniumdihydroxybis(monopropanolaminate), titaniumdihydroxybis(N-methyldiethanolaminate), titaniumdihydroxybis(N-butyldiethanolaminate), a reaction product between tetrahydroxytitanium and N,N,N′,N′-tetrahydroxyethylethylenediamine, intramolecular polycondensates thereof and intermolecular polycondensates thereof.

5. The image forming method of claim 3, wherein the titanium-containing catalyst (a) is a catalyst of formula (II) selected from the group consisting of titanylbis(triethanolaminate), titanylbis(diethanolaminate), titanylbis(monoethanolaminate), titanylhydroxyethanolaminate, titanylhydroxytriethanolaminate, titanylethoxytriethanolaminate, titanylisopropoxytriethanolaminate, intramolecular polycondensates thereof and intermolecular polycondensates thereof.

6. The image forming method of claim 1, wherein the crystalline polyester resin has an acid value of from 20 to 45 mg KOH/g.

7. The image forming method of claim 1, wherein the crystalline polyester resin has a hydroxyl value of from 5 to 50 mg KOH/g.

8. The image forming method of claim 1, wherein the toner further comprises a wax having a melting point of from 70 to 150° C. as a release agent.

9. The image forming method of claim 1, wherein the peak ratio (W/R) is from 0.08 to 0.450.

10. The image forming method of claim 8, wherein the wax is a member selected from the group consisting of carnauba waxes, polyethylene waxes and synthetic ester waxes.
